(19) United States
(12) Patent Application Publication
(10) Pub. No.: US 2009/0090470 A1
(43) Pub. Date: Apr. 9, 2009

(54) COATING FILM TRANSFER TOOL AND ITS TAPE TRANSFER HEAD

(76) Inventor: Ming-Hua YEN, Shulin City (TW)

Correspondence Address: SINORICA, LLC, 528 FALLSGROVE DRIVE, ROCKVILLE, MD, 20850, US

(21) Appl. No.: 12/139,530

(22) Filed: Jun. 16, 2008

(30) Foreign Application Priority Data
Oct. 8, 2007 (TW) 096137654
Apr. 15, 2008 (TW) 097113574

(51) Int. Cl. B32B 37/00

(52) U.S. Cl. 156/459

(57) ABSTRACT

A coating film transfer tool formed of a housing and a tape transfer head is disclosed. The tape transfer head has a narrow elongated neck design, which keeps the coating film transfer tape is kept in a curved vertical status so that the user can see the area to be covered with the coating film. In an alternate form of the invention, the transparent tape base material is kept in the extended horizontal status when moving over the neck after separated of the coating film, so that the user can see the area to be covered with the coating film.

### BACKGROUND OF THE INVENTION

1. Field of the Invention

The present invention relates to a coating film transfer tool for transferring a coating film to a paper and more particularly, to a coating film transfer tool of which the arrangement of the tape transfer head avoids blocking the view of the error to be corrected during application of the coating film.

2. Description of the Related Art

Coating film transfer tool, for example, correction tape is a requisite tool for writers, draftsmen or even ordinary students, for use to correct mistakes during typing, handwriting or drafting. One side of the tape, which is placed against the error, is coated in a white, opaque masking material. Pressure applied to the other side of the tape transfers this material to the paper. Unlike conventional eraser, a coating film transfer tool does not damage the paper when transferring the coating film to the error. Nowadays, you can buy different coating film transfer tools in a stationery store or bookstore.

Basically, a typical conventional coating film transfer tool comprises a housing, which has an outlet, a tape supply mechanism and a tape take-up mechanism mounted inside the housing, a tape transfer head extending out of the outlet of the housing, and a coating film transfer tape, which consists a tape base material coated with a coating film and is wound on the supply reel and extends over the tape transfer head to the take take-up mechanism. During application, the coating film is transferred from the tape base material to the error under a pressure applied to the tape by the tape transfer head against the error. Therefore, the tape transfer head is an important component of a coating film transfer tool.

FIG. 1 illustrates a typical conventional coating film transfer tool. As illustrated, the tape transfer head 10 extends out of the outlet 201 of the housing 20. The housing 20 has a locating device, for example, projecting frame 101 fastened to a mounting portion, for example, mounting groove 202 that is formed on the inside wall of the housing 20 near the outlet 201. The coating film transfer tape 203 extends over the tape transfer head 10. The tape transfer head 10 has two upright stop walls 102 symmetrically disposed at two opposite lateral sides to keep the coating film transfer tape 203 in course and to guide smooth movement of the coating film transfer tape 203.

Any person ever used this kind of coating film transfer tool knows the backback of the coating film transfer tool that the width W of the tape transfer head 10 blocks the user's sight from the part to be covered with the coating film, i.e., letter, line or drawing. When transferring the coating film to the paper, the transferred coating film may be not accurately covered over the whole area of the error. Therefore, an improvement in this regard is necessary.

### SUMMARY OF THE INVENTION

The present invention has been accomplished to provide a coating film transfer tool that eliminates the aforesaid problem.

It is therefore the main object of the present invention to provide a coating film transfer tool, which avoids blocking the view of the area to be covered with the coating film during transfer of the coating film transfer tape.

To achieve this and other objects and according to one embodiment of the present invention, the coating film transfer tool comprises a housing and a tape transfer head. The housing has an outlet. Further, the housing has mounted therein a tape supply mechanism, a tape take-up mechanism, and a coating film transfer tape wound on the tape supply mechanism and extending to the tape take-up mechanism. The tape transfer head is fastened to the outlet for guiding the coating film transfer tape out of the housing through the outlet. The tape transfer head comprises two vertical sidewalls, a transverse partition panel connected between the vertical sidewalls, a tape supply zone defined at one side of the partition panel, a tape take-up zone defined at the opposite side of the partition panel opposing the tape supply zone, a mounting structure disposed at the rear side thereof for fastening to the outlet of the housing, a neck formed of a front part of the vertical sidewalls, a front press portion connected to a front side of the neck, the front press portion having a transverse width greater than the neck, a tape width conversion guide means disposed in the tape supply zone and the tape take-up zone for causing the coating film transfer tape to change between a fully extended horizontal status and a curved vertical status at the neck and at the mounting structure.

To achieve this and other objects and according to one embodiment of the present invention, the coating film transfer tool comprises a housing and a tape transfer head. The housing has an outlet. The housing also has mounted therein a tape supply mechanism, a tape take-up mechanism, and a coating film transfer tape wound on the tape supply mechanism and extending to the tape take-up mechanism. The coating film transfer tape comprises a transparent tape base material, and a coating film coated on the transparent tape base material. The tape transfer head is fastened to the outlet for guiding the coating film transfer tape out of the housing through the outlet. The tape transfer head comprises two vertical sidewalls, a transverse partition panel connected between the vertical sidewalls, a tape supply zone defined at one side of the partition panel, a tape take-up zone defined at the opposite side of the partition panel opposing the tape supply zone, a mounting structure disposed at the rear side thereof for fastening to the outlet of the housing, a neck formed of a front part of the vertical sidewalls, a front press portion connected to a front side of the neck, the front press portion having a transverse width greater than the neck, a tape take-up guide way defined in the rear part thereof between the two vertical sidewalls at one side relative to the partition panel, a tape width conversion guide means disposed in the tape supply zone and the tape take-up zone for causing the coating film transfer tape to change from a fully extended horizontal status to a curved vertical status when the coating film transfer tape passes through the neck and to change from the curved vertical status to the fully extended horizontal status when the coating film transfer tape passes over the front press portion.

It is another object of the present invention to provide a tape transfer head for coating film transfer tool, which avoids blocking the view of the area to be covered with the coating film during transfer of the coating film transfer tape.

To achieve this and other objects and according to one embodiment of the present invention, the tape transfer head is used in a coating film transfer tool to transfer a coating film transfer tape, comprising two vertical sidewalls, a transverse partition panel connected between the vertical sidewalls, a tape supply zone defined at one side of the partition panel, a tape take-up zone defined at the opposite side of the partition panel opposing the tape supply zone, a mounting structure disposed at the rear side thereof for fastening to the outlet of the housing, a neck formed of a front part of the vertical sidewalls, a front press portion connected to a front side of the neck, the front press portion having a transverse width greater than the neck, a tape width conversion guide means disposed in the tape supply zone and the tape take-up zone for causing the coating film transfer tape to change between a fully extended horizontal status and a curved vertical status at the neck and at the mounting structure.

To achieve this and other objects and according to another embodiment of the present invention, the tape transfer head is used in a coating film transfer tool to transfer a coating film transfer tape, comprising two vertical sidewalls, a transverse partition panel connected between the vertical sidewalls, a tape supply zone defined at one side of the partition panel, a tape take-up zone defined at the opposite side of the partition panel opposing the tape supply zone, a mounting structure disposed at the rear side thereof for fastening to the outlet of the housing, a neck formed of a front part of the vertical sidewalls, a front press portion connected to a front side of the neck, the front press portion having a transverse width greater than the neck, a tape take-up guide way defined in the rear part thereof between the two vertical sidewalls at one side relative to the partition panel, a tape width conversion guide means disposed in the tape supply zone and the tape take-up zone for causing the coating film transfer tape to change from a fully extended horizontal status to a curved vertical status when the coating film transfer tape passes through the neck and to change from the curved vertical status to the fully extended horizontal status when the coating film transfer tape passes over the front press portion.

### BRIEF DESCRIPTION OF THE DRAWINGS

FIG. 1 is an elevational view of a coating film transfer tool according to the prior art.

FIG. 2 is an elevational view of a coating film transfer tool in accordance with a first embodiment of the present invention.

FIG. 3 is an oblique top elevation of the tape transfer head of the coating film transfer tool according to the first embodiment of the present invention.

FIG. 4 is an oblique bottom elevation of the tape transfer head of the coating film transfer tool according to the first embodiment of the present invention.

FIG. 5 is a top view of the tape transfer head of the coating film transfer tool according to the first embodiment of the present invention.

FIG. 6 is a schematic drawing showing the coating film transfer tape extended over the tape transfer head according to the first embodiment of the present invention.

FIG. 7 is a schematic drawing showing an application example of the coating film transfer tool according to the first embodiment of the present invention.

FIG. 8 is an elevational view of a coating film transfer tool in accordance with a second embodiment of the present invention.

FIG. 9 is an oblique top elevation of the tape transfer head of the coating film transfer tool according to the second embodiment of the present invention.

FIG. 10 corresponds to FIG. 9 when viewed from another angle.

FIG. 11 is a sectional side view of FIG. 9.

FIG. 12a is a schematic drawing showing the coating film transfer tape extended over the tape transfer head according to the second embodiment of the present invention.

FIG. 12b corresponds to FIG. 12a when viewed from the opposite side.

FIG. 13 is a schematic drawing showing an application example of the coating film transfer tool according to the second embodiment of the present invention.

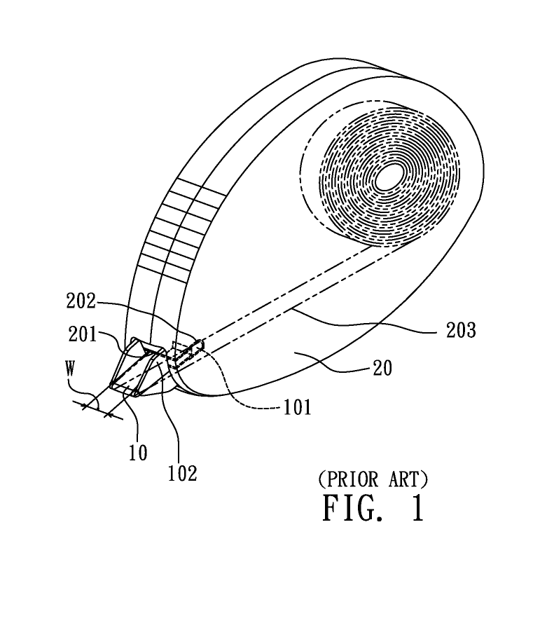

### DETAILED DESCRIPTION OF THE PREFERRED EMBODIMENT

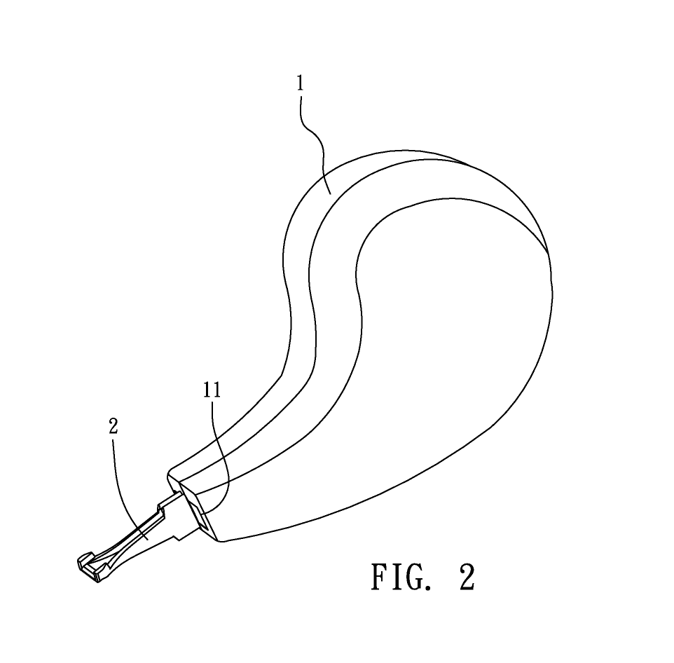

Referring to FIG. 2, a coating film transfer tool in accordance with the present invention is shown comprising a housing 1 and a tape transfer head 2. The housing 1 has mounted therein a known tape supply mechanism and a known tape take-up mechanism (the known mechanisms are not shown). Further, the housing 1 has an outlet 11 through which the tape transfer head 2 extends out of the housing 1. The coating film transfer tape 12 which consists a tape base material coated with a coating film and is wound on the tape supply mechanism extends over the tape transfer head 2 to the tape take-up mechanism so that the housing 1 has tape supplying and taking up function. The tape supplying and taking up function is of the known art, no further detailed description in this regard is necessary.

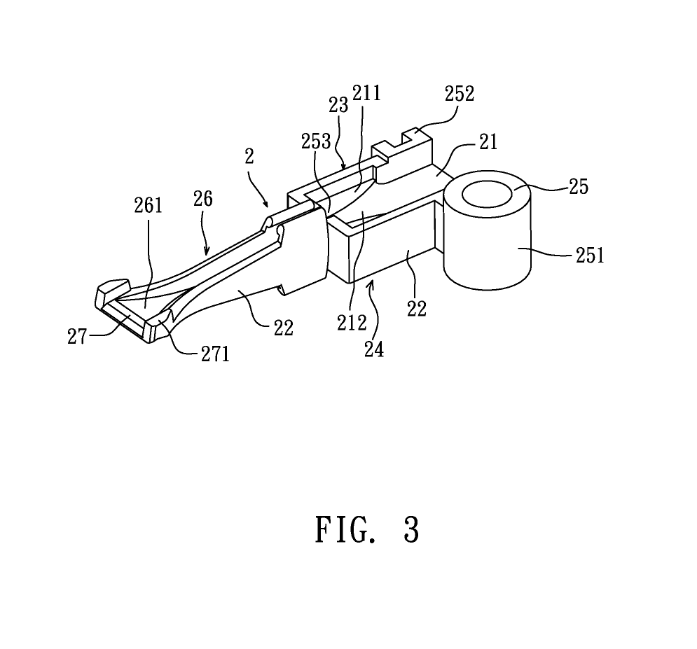

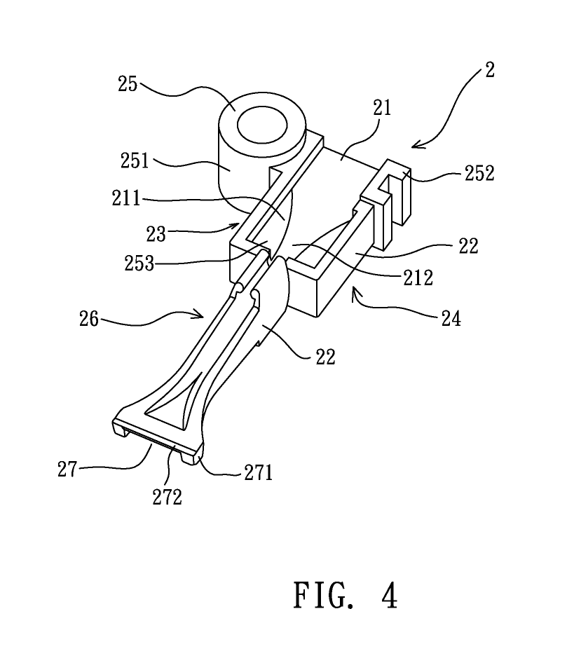

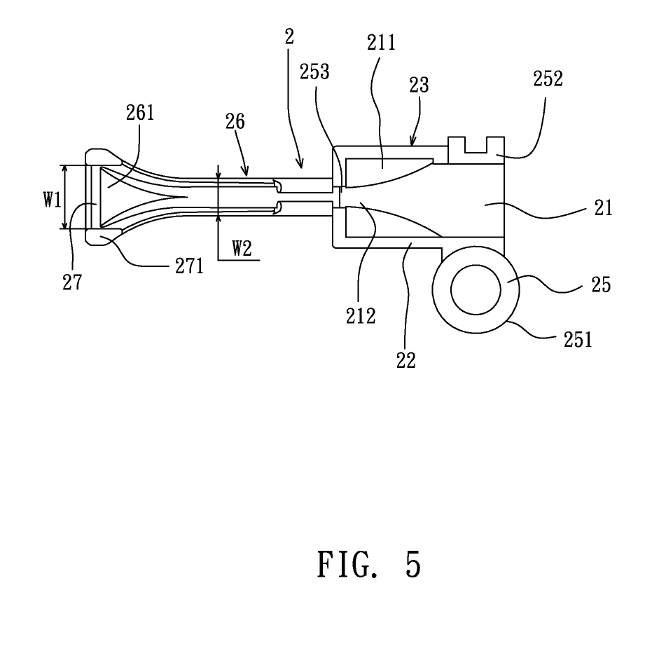

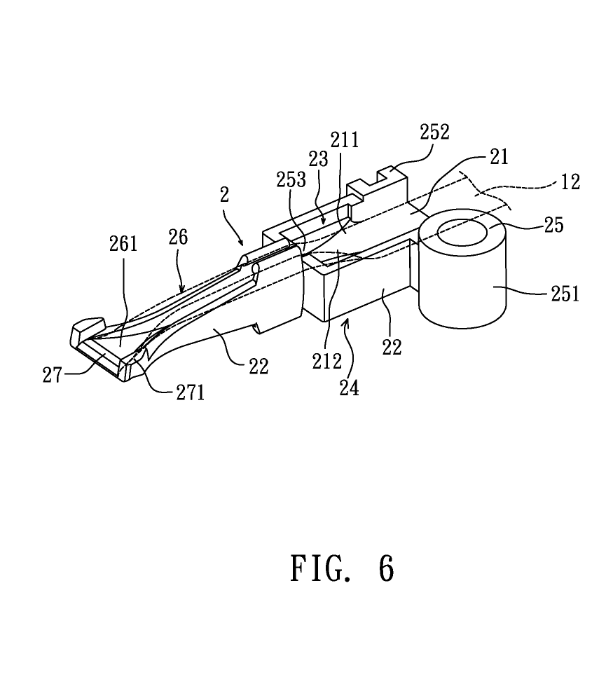

Referring to FIGS. 3˜6 and FIG. 2 again, the tape transfer head 2 comprises two vertical sidewalls 22 arranged in parallel at two opposite lateral sides corresponding to the width of the coating film transfer tape 12, and a partition panel 21 transversely connected between the two vertical sidewalls 22 and defining with the vertical sidewalls 22 a tape take-up zone 23 at the top side and a tape-supply zone 24 at the bottom side. The partition panel 21 has a mounting structure 25 fixedly provided at the rear side. The mounting structure 25 according to this embodiment comprises a barrel 251 and a groove 252 for fastening to positioning means (not shown) inside the outlet 11 of the housing 1. In order to achieve exchange of the coating film transfer tape 12 (see the imaginary line) between a fully extended horizontal status and a curved vertical status, for example, between a flat shape and a U or V shape during the tape supply or tape take-up process so as to effectively reduce the width of the coating film transfer tape 12, as shown in FIG. 5, from the first width W1 to the second width W2, a narrow elongated neck 26 extends forward from the two vertical sidewalls 22 and terminating in a front press portion 27, and a neck gate 253 is formed in each of the tape take-up zone 23 and tape-supply zone 24 in between the two vertical sidewalls 22 and connected to the neck 26. As shown in FIG. 3, the partition panel 21 has two smoothly arched guide flanges 211 respectively projecting from the tape take-up zone 23 and the tape-supply zone 24 toward the neck gate 253 so that a funnel-like inner guide way 212 is defined in each of the tape take-up zone 23 and tape-supply zone 24 between the two smoothly arched guide flanges 211. During application, the coating film transfer tape 12 is caused by the funnel-like inner guide way 212 in the tape supply zone 24 to change from the fully extended horizontal status to the curved vertical status and then to pass through the neck gate 253 in one side of the partition panel 21 and the neck 26 over the front press portion 27 and then to pass through the neck gate 253 in the other side of the partition panel 21 toward the mounting structure 25. When the coating film transfer tape 12 is extending over the front press portion 27 toward the mounting structure 25 through the neck gate 253, it is guided by the funnel-like inner guide way 212 in the tape take-up zone 23 to change from the curved vertical status to the fully extended horizontal status so that the tape take-up mechanism takes up the coating film transfer tape 12 smoothly.

The neck 26 that is formed of a front part of the two vertical sidewalls 22 has a transverse width smaller than the width of the coating film transfer tape 12 so that the neck 26 does not block the view of the whole surface area to be covered with the coating film. Therefore, when the coating film transfer tape 12 is extending through the neck 26, it is kept in the curved vertical status. When the coating film transfer tape 12 passes through the front side of the neck 26, it is caused by a funnel-like outer guide way 261 defined between the two vertical sidewalls 22 to change between the curved vertical status and the fully extended horizontal status. The front press portion 27 is disposed at the front side of the funnel-like outer guide way 261, having two vertical stop walls 271 respectively disposed at the two distal ends thereof for guiding the coating film transfer tape 12. The gap between the two vertical stop walls 271 corresponds to the width of the coating film transfer tape 12 so that the coating film transfer tape 12 extends smoothly over the front press portion 27. The front press portion 27 further has a beveled face 272 for imparting a pressure to the coating film transfer tape 12 against the receiving surface (the error) to be corrected when the coating film transfer tool is being moved over the paper to have the tape supply mechanism and tape take-up mechanism perform the tape supplying and taking up function, so that the receiving surface (error) can be covered with the coating film accurately.

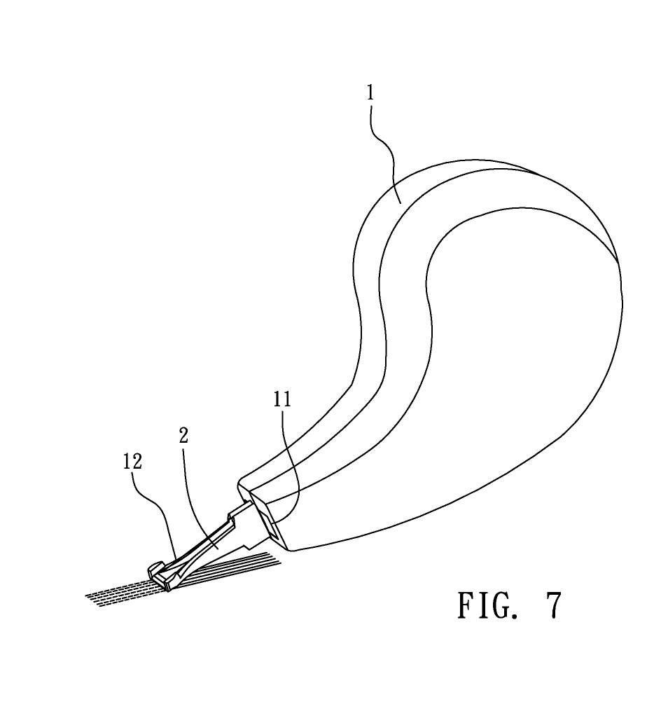

FIG. 2 shows the housing 1 and the tape transfer head 2 assembled. During application, as shown in FIG. 7, the tape supply mechanism lets off the coating film transfer tape 12. At this time, the tape gathering effect of the funnel-like inner guide way 212 in the tape-supply zone 24 causes the coating film transfer tape 12 to change from the fully extended horizontal status to the curved vertical status and to pass through the lower neck gate 253 and the middle neck 26, and the coating film transfer tape 12 is then guided by the funnel-like outer guide way 261 to change from the curved vertical status to fully extended horizontal status and to pass over the front press portion 27 toward the inside of the housing 1. Therefore, the narrow elongated neck 26 does not block the user's sight from viewing the application of the coating film to the surface area of the paper to be covered with the coating film. After removal of the coating film, the tape base material of the coating film transfer tape 12 extends from the front press portion 27 through the funnel-like outer guide way 261 in the neck 26 where the funnel-like outer guide way 261 causes the coating film transfer tape 12 to change from the fully extended horizontal status to the curved vertical status, and then to the funnel-like inner guide way 212 through the upper neck gate 253 where the funnel-like inner guide way 212 causes the coating film transfer tape 12 to change from the curved vertical status to the fully extended horizontal status for receiving by the tape take-up mechanism.

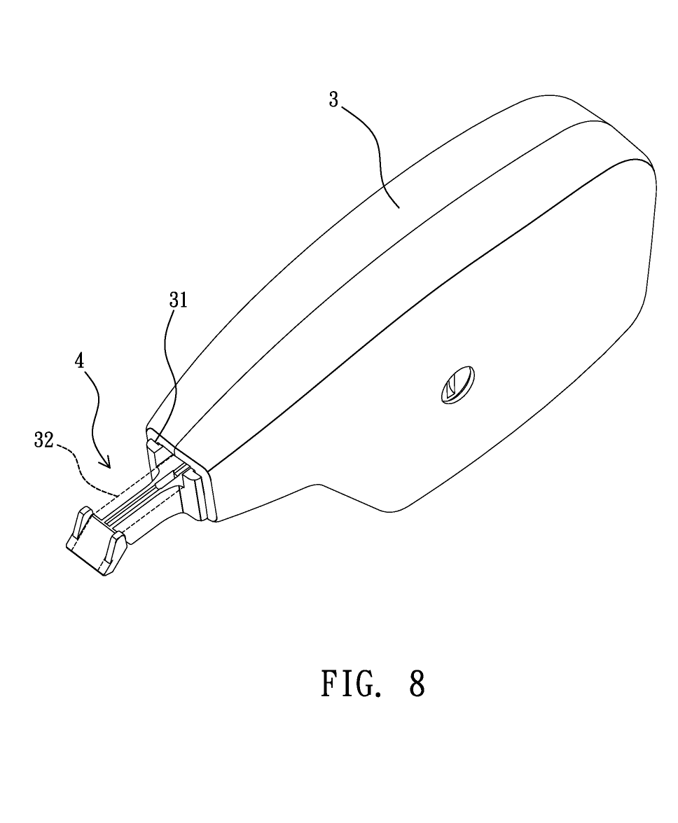

FIG. 8 illustrates a coating film transfer tool in accordance with a second embodiment of the present invention. According to this second embodiment, the coating film transfer tool is comprised of a housing 3 and a tape transfer head 4.

Same as the aforesaid first embodiment, the housing 3 according to this second embodiment has mounted therein a tape supply mechanism and a tape take-up mechanism (not shown). Further, the housing 3 has an outlet 31 through which the tape transfer head 4 extends out of the housing 3. The coating film transfer tape, referenced by 32, which is wound on the tape supply mechanism extends over the tape transfer head 4 to the tape take-up mechanism so that the housing 3 has tape supplying and taking up function. The coating film transfer tape 32 consists a tape base material coated with a coating film. The tape supplying and taking up function is of the known art, no further detailed description in this regard is necessary.

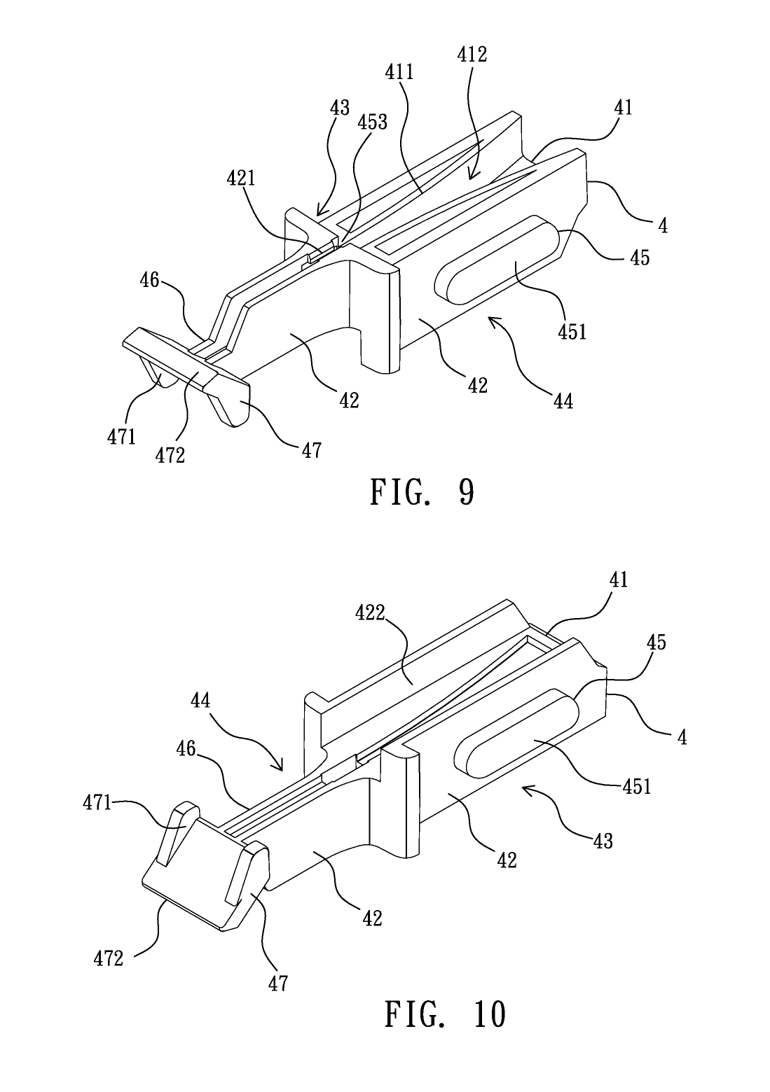

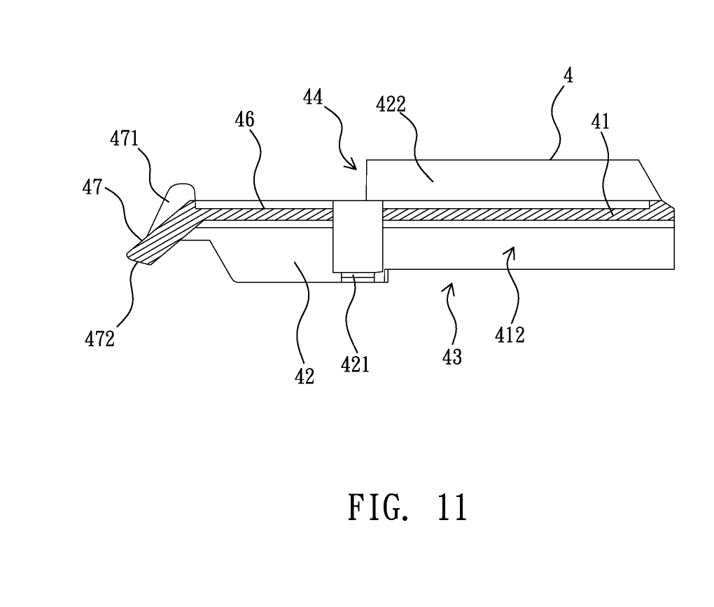

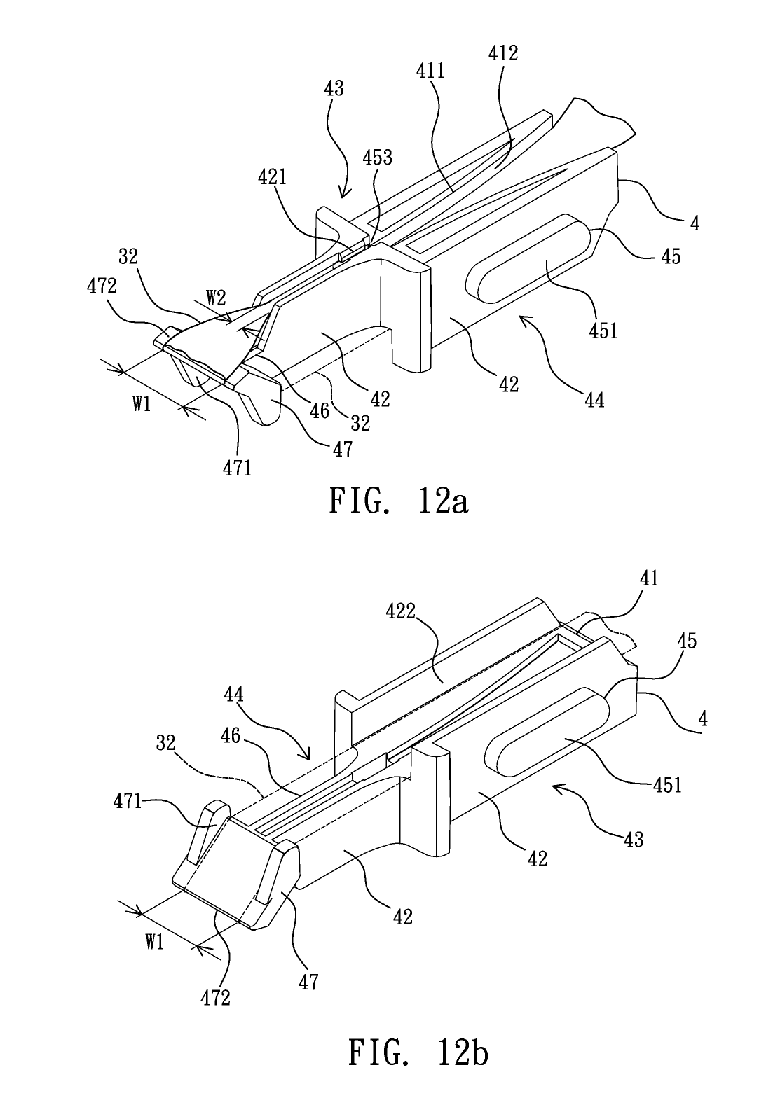

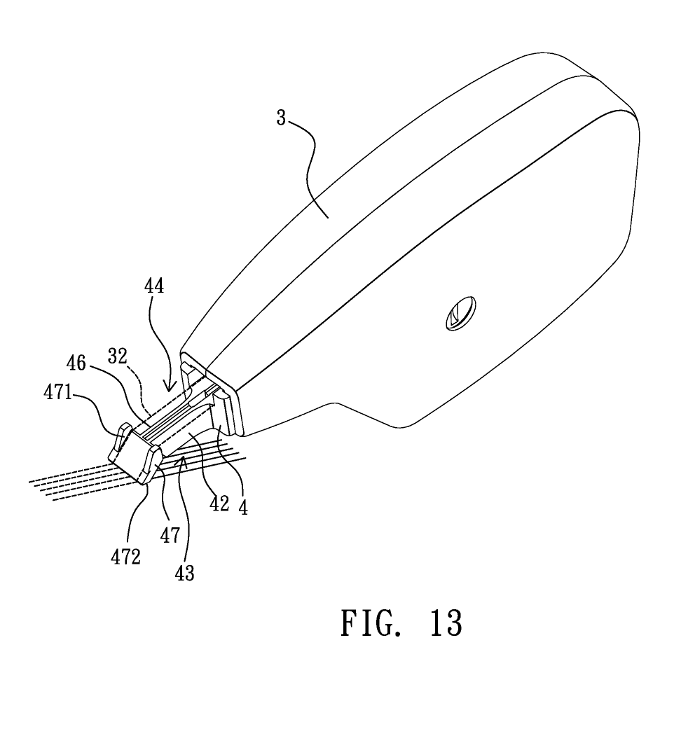

Referring to FIGS. 9 through 13 and FIG. 8 again, the tape transfer head 4 comprises two vertical sidewalls 42 and a partition panel 41 transversely connected between the two vertical sidewalls 42. The gap in the rear part between the two vertical sidewalls 42 corresponds to the width of the coating film transfer tape 32. The two vertical sidewalls 42 define in the rear part a tape supply zone 43 beneath the partition panel 41 and a tape take-up zone 44 above the partition panel 41. The tape transfer head 4 further comprises a mounting structure 45 near the rear side. The mounting structure 45 is comprised of two locating blocks 451 respectively protruded from the two vertical sidewalls 42 for fastening to respective locating grooves (not shown) inside the outlet 31 of the housing 3. Alternatively, the mounting structure 45 can be comprised of two locating grooves respectively formed on the two vertical sidewalls 42 for fastening to respective locating blocks inside the outlet 31 of the housing 3. In order to achieve exchange of the coating film transfer tape 32 (see the imaginary line) between a fully extended horizontal status and a curved vertical status, for example, between a flat shape and a U or V shape during the tape supply or tape take-up process so as to effectively reduce the width of the coating film transfer tape 32, as shown in FIG. 9, from the first width W1 to the second width W2, a neck gate 453 is formed in between the two vertical sidewalls 42 and connected to the neck 46 that is formed of the front part of the two vertical sidewalls 42. For guiding the coating film transfer tape 32 to change its width in a gradually reducing manner, two smoothly curved guide flanges 411 are respectively protruded from the two vertical sidewalls 42. The two smoothly curved guide flanges 411 define therebetween a funnel-like inner guide way 412 in communication with the neck gate 453 for causing the coating film transfer tape 32 to change from the fully extended horizontal status to the curved vertical status before entering the neck 46.

When the tape supply mechanism in the housing 3 lets off the coating film transfer tape 32, the funnel-like inner guide way 412 in the tape supply zone 43 causes the coating film transfer tape 32 to change from the fully extended horizontal status to the curved vertical status before entering the neck gate 453 and the neck 46. Because the width of the neck 46 is shorter than the receiving surface (error) to be covered with the coating film, the neck 46 does not block the user's sight from viewing the receiving surface (error). When extending out of the neck 46 over the front press portion, referenced by 47, the coating film transfer tape 32 is free from the constraint of the vertical sidewalls 42, and immediately extends out from the curved vertical status to the fully extended horizontal status so that the front press portion 47 can be forced to press the coating film transfer tape 32 onto the receiving surface (error) to be corrected, and then moved to have the coating film be adhered to the receiving surface (error) and the tape base material be taken up by the tape take-up mechanism. Further, each vertical sidewall 42 has a top stop flange 421 that prohibits the coating film transfer tape 32 from falling out of the neck 46.

The front press portion 47 slopes at an angle toward the tape take-up zone 44, and is connected to the bottom side of the neck 46. Further, the front press portion 47 has two vertical stop walls 471 respectively disposed at the two distal ends thereof corresponding to the width of the coating film transfer tape 32 to facilitate smooth movement of the coating film transfer tape 32 over the front press portion 47 toward the inside of the housing 3 via the tape take-up guide way 422, which is defined in the rear part between the two vertical sidewalls 42 at one side of the partition panel 41 opposite to the funnel-like inner guide way 412, enabling the tape take-up mechanism to tack up the tape base material smoothly. When the beveled face 472 of the front press portion 47 is pressed onto the coating film transfer tape 32 against the receiving surface (error) to be corrected and moved, the coating film is separated from the transparent tape base material of the coating film transfer tape 32 and covered over the where area of the receiving surface (error), and the transparent tape base material is being moved through the tape take-up zone 44 and taken up by the tape take-up mechanism without blocking the user's sight from viewing the application of the coating film to the receiving surface (error).

FIG. 8 shows the tape transfer head 4 and the housing 3 assembled. During application, as shown in FIG. 13, the tape supply mechanism lets off the coating film transfer tape 32. At this time, the tape gathering effect of the funnel-like inner guide way 412 in the tape supply zone 43 causes the coating film transfer tape 32 to change from the fully extended horizontal status to the curved vertical status and to pass through the neck gate 453 and the neck 46. When moved to the front press portion 47, the coating film transfer tape 32 is released from the constraint of the two vertical sidewalls 42 and returns from the curved vertical status to the fully extended horizontal status so that the fully extended coating film transfer tape 32 can be pressed onto the paper by the front press portion 47 to have the coating film be separated from the transparent tape base material and covered on the receiving surface (error). At this time, the user can see through the transparent tape base material beyond the neck 46, observing the receiving surface (error) to be covered with the coating film, and therefore the receiving surface (error) can be covered with the coating film accurately. The transparent tape base material of the coating film transfer tape 32 extends over the front press portion 47 through the tape take-up zone 44 into the tape take-up guide way 422 in the rear part between the two vertical sidewalls 42, and it is taken up by the tape take-up mechanism smoothly.

According to the first embodiment of the present invention, the design of the narrow elongated neck of the tape guide, the coating film transfer tape is kept in a vertical status to reduce the width when passing through the tape supply zone, allowing the user to observe the receiving surface (error) that is to be covered with the coating film. According to the second embodiment of the present invention, when the coating film transfer tape is moving through the take take-up zone, the coating film has been taken away, and the transparent tape base material is kept in the fully extended horizontal status, and the user can see through the transparent tape base material to observe the receiving surface (error) that is to be covered with the coating film. By means of the application of the present invention, hand-eye alignment is achieved to avoid transfer of the coating film to an area that does not need to be erased, or the problem where the length of the transferred coating film is insufficient to cover section to be erased. Further, the two vertical sidewalls of the neck keep the coating film transfer tape in the vertical status and reinforce the structural strength of the tape transfer head, facilitating the operation of the coating film transfer tool.

Although particular embodiments of the invention have been described in detail for purposes of illustration, various modifications and enhancements may be made without departing from the spirit and scope of the invention.

What is claimed is:

1. A coating film transfer tool comprising:
a housing, said housing having an outlet and having mounted therein a tape supply mechanism and a tape take-up mechanism and a coating film transfer tape wound on said tape supply mechanism and extending to said tape take-up mechanism; and
a tape transfer head fastened to said outlet for guiding said coating film transfer tape out of said housing through said outlet, said tape transfer head comprising two vertical sidewalls, a transverse partition panel connected between said vertical sidewalls, a tape supply zone defined at one side of said partition panel, a tape take-up zone defined at an opposite side of said partition panel opposing said tape supply zone, a mounting structure disposed at a rear side thereof for fastening to said outlet of said housing, a neck formed of a front part of said vertical sidewalls, a front press portion connected to a front side of said neck, said front press portion having a transverse width greater than said neck, a tape width conversion guide means disposed in said tape supply zone and said tape take-up zone for causing said coating film transfer tape to change between a fully extended horizontal status and a curved vertical status at said neck and at said mounting structure.

2. The coating film transfer tool as claimed in claim 1, wherein said tape width conversion guide means comprises two smoothly arched guide flanges respectively protruded from said vertical sidewalls and a funnel-like guide way defined between said two smoothly arched guide flanges between said mounting structure and said neck.

3. The coating film transfer tool as claimed in claim 1, wherein each said vertical sidewall has a smoothly arched inner part; said tape width conversion guide means comprises a funnel-like guide way defined between the smoothly arched inner part of each of said two smoothly arched guide flanges.

4. The coating film transfer tool as claimed in claim 1, wherein said fully extended status is a flat status, and said curved vertical status is a U-shaped status or V-shaped status.

5. The coating film transfer tool as claimed in claim 1, wherein said front press portion has a front sloping face, and two vertical stop walls disposed at two opposite lateral sides of said front sloping face and spaced from each other at a distance corresponding to the width of said coating film transfer tape.

6. The coating film transfer tool as claimed in claim 1, wherein said mounting structure comprises at least one barrel, groove, locating block and/or the combination thereof.

7. A coating film transfer tool comprising:
a housing, said housing having an outlet and having mounted therein a tape supply mechanism and a tape take-up mechanism and a coating film transfer tape wound on said tape supply mechanism and extending to said tape take-up mechanism, said coating film transfer tape comprising a transparent tape base material and a coating film coated on said transparent tape base material; and
a tape transfer head fastened to said outlet for guiding said coating film transfer tape out of said housing through said outlet, said tape transfer head comprising two vertical sidewalls, a transverse partition panel connected between said vertical sidewalls, a tape supply zone defined at one side of said partition panel, a tape take-up zone defined at an opposite side of said partition panel opposing said tape supply zone, a mounting structure disposed at a rear side thereof for fastening to said outlet of said housing, a neck formed of a front part of said vertical sidewalls, a front press portion connected to a front side of said neck, said front press portion having a transverse width greater than said neck, a tape take-up guide way defined in a rear part thereof between said two vertical sidewalls at one side relative to said partition panel, a tape width conversion guide means disposed in said tape supply zone and said tape take-up zone for causing said coating film transfer tape to change from a fully extended horizontal status to a curved vertical status when said coating film transfer tape passes through said neck and to change from said curved vertical status to said fully extended horizontal status when said coating film transfer tape passes over said front press portion;
wherein when said tape supply mechanism is letting off said coating film transfer tape, said front press portion is being pressed on said coating film transfer tape against a receiving surface and moved to have said coating film be separated from said transparent tape base material and covered on said receiving surface, said transparent tape base material is been moved through a bottom side of said neck and said tape take-up guide way and taken up by said tape take-up mechanism.

8. The coating film transfer tool as claimed in claim 7, wherein said tape width conversion guide means comprises two smoothly arched guide flanges respectively protruded from said vertical sidewalls and a funnel-like guide way defined between said two smoothly arched guide flanges between said mounting structure and said neck.

9. The coating film transfer tool as claimed in claim 7, wherein said fully extended status is a flat status, and said curved vertical status is a U-shaped status or V-shaped status.

10. The coating film transfer tool as claimed in claim 7, wherein said front press portion has a front sloping face, and two vertical stop walls disposed at two opposite lateral sides of said front sloping face and spaced from each other at a distance corresponding to the width of said coating film transfer tape.

11. The coating film transfer tool as claimed in claim 7, wherein each said vertical sidewall has a top stop flange suspending in a top side of said neck for keeping said coating film transfer tape in said neck.

12. The coating film transfer tool as claimed in claim 7, wherein said mounting structure comprises at least one barrel, groove, locating block and/or the combination thereof.

13. A tape transfer head for use in a coating film transfer tool to transfer a coating film transfer tape, said tape transfer head comprising two vertical sidewalls, a transverse partition panel connected between said vertical sidewalls, a tape supply zone defined at one side of said partition panel, a tape take-up zone defined at an opposite side of said partition panel opposing said tape supply zone, a mounting structure disposed at a rear side thereof for fastening to said outlet of said housing, a neck formed of a front part of said vertical sidewalls, a front press portion connected to a front side of said neck, said front press portion having a transverse width greater than said neck, a tape width conversion guide means disposed in said tape supply zone and said tape take-up zone for causing said coating film transfer tape to change between a fully extended horizontal status and a curved vertical status at said neck and at said mounting structure.

14. The tape transfer head as claimed in claim 13, wherein said tape width conversion guide means comprises two smoothly arched guide flanges respectively protruded from said vertical sidewalls and a funnel-like guide way defined between said two smoothly arched guide flanges between said mounting structure and said neck.

15. The tape transfer head as claimed in claim 13, wherein each said vertical sidewall has a smoothly arched inner part; said tape width conversion guide means comprises a funnel-like guide way defined between the smoothly arched inner part of each of said two smoothly arched guide flanges.

16. The tape transfer head as claimed in claim 13, wherein said fully extended status is a flat status, and said curved vertical status is a U-shaped status or V-shaped status.

17. The tape transfer head as claimed in claim 13, wherein said front press portion has a front sloping face, and two vertical stop walls disposed at two opposite lateral sides of said front sloping face and spaced from each other at a distance corresponding to the width of said coating film transfer tape.

18. The tape transfer head as claimed in claim 13, wherein said mounting structure comprises at least one barrel, groove, locating block and/or the combination thereof.

19. A tape transfer head for use in a coating film transfer tool to transfer a coating film transfer tape, said tape transfer head comprising two vertical sidewalls, a transverse partition panel connected between said vertical sidewalls, a tape supply zone defined at one side of said partition panel, a tape take-up zone defined at an opposite side of said partition panel opposing said tape supply zone, a mounting structure disposed at a rear side thereof for fastening to said outlet of said housing, a neck formed of a front part of said vertical sidewalls, a front press portion connected to a front side of said neck, said front press portion having a transverse width greater than said neck, a tape take-up guide way defined in a rear part thereof between said two vertical sidewalls at one side relative to said partition panel, a tape width conversion guide means disposed in said tape supply zone and said tape take-up zone for causing said coating film transfer tape to change from a fully extended horizontal status to a curved vertical status when said coating film transfer tape passes through said neck and to change from said curved vertical status to said fully extended horizontal status when said coating film transfer tape passes over said front press portion.

20. The tape transfer head as claimed in claim 19, wherein said tape width conversion guide means comprises two smoothly arched guide flanges respectively protruded from said vertical sidewalls and a funnel-like guide way defined between said two smoothly arched guide flanges between said mounting structure and said neck.

21. The tape transfer head as claimed in claim 19, wherein said fully extended status is a flat status, and said curved vertical status is a U-shaped status or V-shaped status.

22. The tape transfer head as claimed in claim 19, wherein said front press portion has a front sloping face, and two vertical stop walls disposed at two opposite lateral sides of said front sloping face and spaced from each other at a distance corresponding to the width of said coating film transfer tape.

23. The tape transfer head as claimed in claim 19, wherein each said vertical sidewall has a top stop flange suspending in a top side of said neck for keeping said coating film transfer tape in said neck.

24. The tape transfer head as claimed in claim 19, wherein said mounting structure comprises at least one barrel, groove, locating block and/or the combination thereof.
